(19) United States
(12) Patent Application Publication
(10) Pub. No.: US 2005/0135500 A1
(43) Pub. Date: Jun. 23, 2005

(54) Space-time block coding method using auxiliary symbol

(75) Inventors: Seung-Hoon Nam, Seoul (KR); Yung-Soo Kim, Seongnam-si (KR); Jae-Hak Chung, Seoul (KR); Vahid Tarokh, Cambridge, MA (US); Chan-Soo Hwang, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/020,804

(22) Filed: Dec. 23, 2004

Related U.S. Application Data
(60) Provisional application No. 60/532,238, filed on Dec. 23, 2003.

(30) Foreign Application Priority Data
Nov. 30, 2004 (KR) 2004-99464

(51) Int. Cl. H04L 1/02

(52) U.S. Cl. 375/267

(57) ABSTRACT

A space-time block coding method using an auxiliary symbol in a multiple transmit/receive antenna system is provided. In the space-time block coding method, binary data to be transmitted is received. Free symbols and an auxiliary symbol are generated by dividing the received binary data into units of a predetermined number of bits. The free symbols and the auxiliary symbol are encoded according to an encoding matrix and transmitted.

### PRIORITY

This application claims priority under 35 U.S.C. § 119 to an application entitled “Constrained Space Time Block Codes Which Provide A Variety Of Trade-Offs Between Transmission And Diversity Gain” filed in the United States Patent and Trademark Office on Dec. 23, 2003 and assigned Ser. No. 60/532,238, and under 35 U.S.C. § 119 to an application entitled “Space-Time Block Coding Method Using Auxiliary Symbol” filed in the Korean Intellectual Property Office on Nov. 30, 2004 and assigned Serial No. 2004-99464, the contents of which are incorporated herein by reference.

### BACKGROUND OF THE INVENTION

1. Field of the Invention

The present invention relates to a space-time block coding method in which an auxiliary symbol is introduced to control a data rate and a transmit diversity order during space-time block coding, in a Multiple Input Multiple Output (MIMO) communication system using multiple transmit antennas.

2. Description of the Related Art

For the transmission of a complex signal, existing orthogonal space-time block codes offer a maximum data rate of one symbol/transmission for two transmit antennas, and a maximum data rate of 0.75 symbol/transmission for three or more transmit antennas.

The space-time block coding proposed by Tarokh et. al is an extension of Alamouti's transmit antenna diversity for a plurality of antennas. The orthogonal space-time block coding is known which has a data rate of 1 for two transmit antennas and a data rate of 0.75 for three or four transmit antennas in order to transmit a complex signal. It was proved that the orthogonal space-time block coding having a data rate of 1 is viable only for two transmit antennas, and no orthogonal space-time block codes are known which offer a data rate exceeding 0.75 for three or more transmit antennas.

FIGS. 1A and 1B are block diagrams of a conventional orthogonal space-time block coding apparatus.

FIG. 1A is a block diagram of a transmitter used in a conventional orthogonal space-time block coding apparatus. Referring to FIG. 1A, the transmitter includes N transmit antennas (ANT 1 to ANT N) 103-1 to 103-N. The transmitter is composed of a symbol mapper 101 for generating Nt symbols from input binary data b₁b₂ . . . bᵢ by mapping every 2^{b} bits to one symbol, and a space-time block encoder 102 for generating space-time block codes using an encoding matrix from symbols received from the symbol mapper 101 and providing the space-time block codes to the respective transmit antennas 103-1 to 103-N.

When the number of transmit antennas N is 2, Nₜ is 2. For N=3 or 4, Nt is 3. For N=2, 3 and 4, the coding matrices are shown in Equations 1, 2 and 3:

$$\begin{matrix}{H}_{22} = [ \begin{matrix}{s}_{1} & {s}_{2} \\ - {s}_{2}^{*} & {s}_{1}^{*}\end{matrix} ] & ( 1 ) \\ {H}_{43} = [ \begin{matrix}{s}_{1} & {s}_{2} & {s}_{3} \\ - {s}_{2}^{*} & {s}_{1}^{*} & 0 \\ {s}_{3}^{*} & 0 & - {s}_{1}^{*} \\ 0 & {s}_{3}^{*} & - {s}_{2}^{*}\end{matrix} ] & ( 2 ) \\ {H}_{44} = [ \begin{matrix}{s}_{1} & {s}_{2} & {s}_{3} & 0 \\ - {s}_{2}^{*} & {s}_{1}^{*} & 0 & {s}_{3} \\ {s}_{3}^{*} & 0 & - {s}_{1}^{*} & {s}_{2} \\ 0 & {s}_{3}^{*} & - {s}_{2}^{*} & - {s}_{1}\end{matrix} ] & ( 3 )\end{matrix}$$

where H₂₂, H₄₃ and H₄₄ represent space-time block codes for N=2, 3 and 4, respectively. In each of the matrices, an ith row represents a signal transmitted at an i^{th} time and a j^{th} column represents a signal transmitted through a j^{th} transmit antenna.

Coding using the encoding matrix occurs in the space-time block encoder 102 in FIG. 1A.

FIG. 1B is a block diagram of a receiver having N′ receive antennas 104-1′ to 104-N′ in the space-time block coding apparatus. Referring to FIG. 1B, the receiver is comprised of a channel estimator 105 for performing a channel estimation on a space-time block code received from the transmitter, a space-time block decoder 106 for computing a decision metric corresponding to the transmitted signal by multiplying the channel estimation value by the space-time block code received through the receive antennas 104-1′ to 104-N′ and thus estimating symbols, and a symbol demapper 107 for generating binary data from the estimated symbols. For details, see Tarokh, et. al., “Space Time Block Coding from Original Design”, IEEE Trans. On Info. Theory, Vol. 45, pp. 1456-1467, July 1999.

The above space-time block coding offers a transmit diversity gain that increase with the number of transmit antennas. However, the data rate is 1 for H₂₂ because two symbols are transmitted over two symbol periods, and the data rate is 0.75 for H₄₃ and H₄₃ because three symbols are transmitted over four symbol periods. Aside from these space-time block codes, it was proved that a data rate exceeding 1 cannot be achieved with any other encoding matrix for use in various space-time block coding schemes.

### SUMMARY OF THE INVENTION

Since the benefits of a multiple transmit/receive antenna system are diversity gain that improves error detection performance for a transmitted signal and multiplexing gain that allows simultaneous transmission of a large volume of data, the limitations on data rate counterbalances hinder full use of the benefits. Also, fixing a data rate according to the number of the transmit antennas used decreases system flexibility in using space-time block codes.

An object of the present invention is to substantially solve at least the above problems and/or disadvantages and to provide at least the advantages below. Accordingly, an object of the present invention is to provide a space-time block coding method using an auxiliary symbol, for maintaining the orthogonality of a space-time block code and achieving a higher data rate than that of existing orthogonal space-time block coding schemes, while minimizing decoding complexity associated with an auxiliary symbol, and controlling data rate and diversity order.

The above object is achieved by providing a space-time block coding method using an auxiliary symbol in a multiple transmit/receive antenna system. In the space-time block coding method, binary data to be transmitted is received. Free symbols and an auxiliary symbol are generated by dividing the received binary data into units of a predetermined number of bits. The free symbols and are the auxiliary symbol are encoded according to an encoding matrix and transmitted.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B are block diagrams of a conventional orthogonal space-time block coding apparatus;

FIG. 2 is a graph illustrating the performance of typical space-time block coding;

FIGS. 3A and 3B are block diagrams of an orthogonal space-time block coding apparatus according to an embodiment of the present invention;

FIG. 4 is a flowchart illustrating a space-time block coding method according to the embodiment of the present invention;

FIGS. 5A to 5D are graphs comparing conventional orthogonal space-time block coding with the orthogonal space-time block coding of the present invention in terms of BER (Bit Error Rate) in the case where two transmit antennas are used; and

FIGS. 6A and 6B are graphs comparing the conventional orthogonal space-time block coding with the orthogonal space-time block coding of the present invention in terms of BER in the case where three transmit antennas are used.

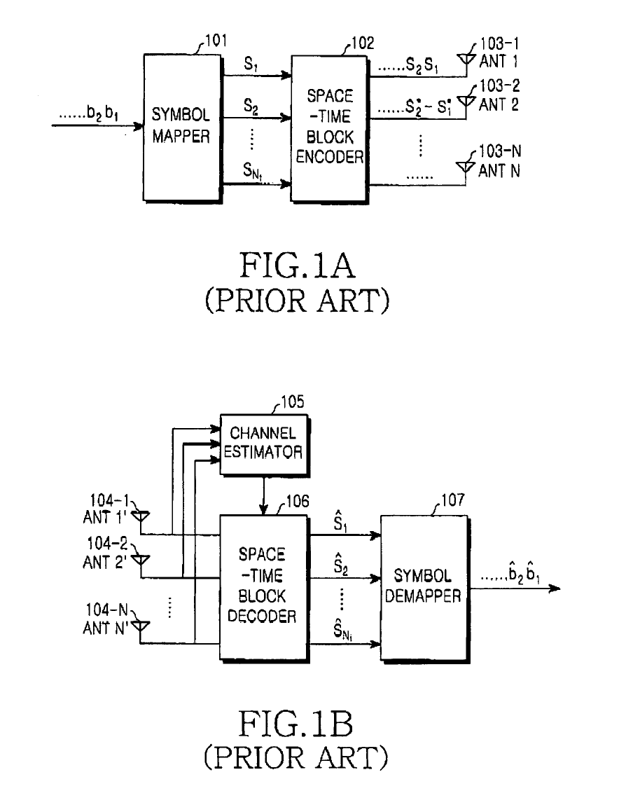

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

A multiple transmit/receive antenna system offers two main benefits. One is to improve the error detection performance of a transmitted signal by implementing signal diversity and the other is to increase the data rate by transmitting a large amount of data at the same time through the process of multiplexing. Space-time block coding is a scheme of achieving transmit diversity using multiple transmit antennas.

When sufficient transmit diversity can be achieved by increasing the number of transmit antennas in the transmitter, or when despite a lack of transmit antennas, sufficient receive diversity can be achieved by increasing the number of receive antennas, the performance improvement that a diversity gain can bring is saturated. Limiting the use of space-time block codes to acquire transmit diversity as conventionally done is ineffective. In this context, an embodiment of the present invention provides a method of improving system performance by increasing the data rate rather than the diversity gain.

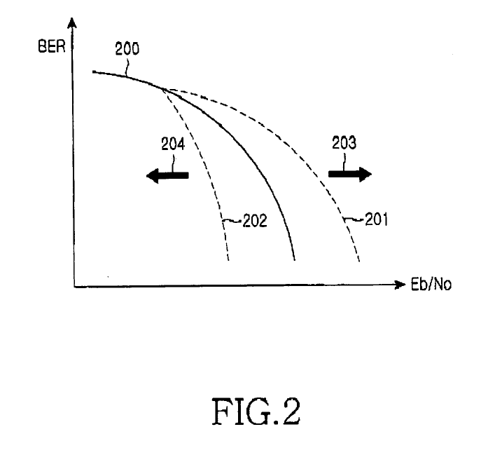

FIG. 2 is a graph illustrating the performance of typical space-time block coding. Referring to FIG. 2, a curve 200 denotes the basic performance of the typical space-time block coding, showing the list error rate versus the signal to noise ratio. The performance may be changed according to a diversity order and a data rate.

As the diversity order increases, the curve 200 is changed to a curve 202 as the absolute value of its inclination increases. This implies that the performance is improved. On the contrary, if the diversity order decreases, the absolute value of the inclination is decreased, thereby changing the curve 200 to a curve 201 with a decreased performance.

When the data rate increases, the curve 200 is shifted to a curve 204 with the same shape but an improved performance.

In this way, the diversity order changes the inclination of the performance curve and the data rate changes the reference point of the performance curve.

The diversity order is the product between the number of transmit antennas and the number of receive antennas. If the diversity order is equal to or greater than a predetermined threshold, there is little change in the diversity order. Therefore, in the case where a plurality of receive antennas are used, a transmitter can improve performance by increasing the data rate rather than by changing the diversity order.

The space-time block coding was designed based on the orthogonality of a transmission encoding matrix. This feature limits the data rate. Hence, a maximum data rate is limited to 1 or less for any number of transmit antennas. However, the present invention introduces the concept of an auxiliary symbol to solve the problem.

A transmission encoding matrix has the following features in a space-time block coding method according to the present invention.

Every element in the transmission encoding matrix is a variable or a set of variables. Some of the elements of the transmission encoding matrix are symbols determined from input binary data. These symbols are referred to as free symbols.

Another grove of the elements of the matrix are defined as the products between the free symbols and an auxiliary symbol. The auxiliary symbol is a QPSK (Quadrature Phase Shift Keying) symbol always having a value of {−1, 1, −j, j} that makes the inner product between two columns in the matrix equal to zero. The auxiliary symbol is always multiplied by a free symbol to be an element in the matrix.

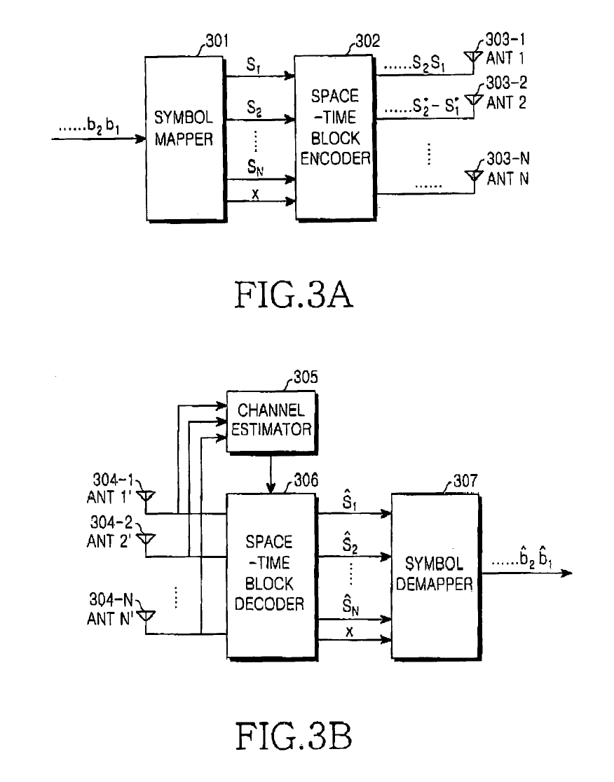

FIGS. 3A and 3B are block diagrams of an orthogonal space-time block coding apparatus according to an embodiment of the present invention.

FIG. 3A is a block diagram of a transmitter having N transmit antennas (ANT 1 to ANT N) 303-1 to 303-N in the orthogonal space-time block coding apparatus according to the embodiment of the present invention. Referring to FIG. 3A, the transmitter is composed of a symbol mapper 301 for generating Nt symbols from the input binary data b₁b₂ . . . bᵢ by mapping every 2^{b} bits to one symbol, and generating a QPSK auxiliary symbol x, and a space-time block encoder 302 for generating space-time block codes using an encoding matrix from symbols received from the symbol mapper 301 and providing the space-time block codes to the respective transmit antennas 303-1 to 303-N.

For N=2, Nₜ is 2. For N=3 or 4, Nₜ is 4. For N=2, 3 and 4, the respective coding matrices are shown in Equations 4, 5 and 6:

$$\begin{matrix}{G}_{22} = [ \begin{matrix}{s}_{1} & {s}_{2} \\ - x {s}_{2}^{*} & x {s}_{1}^{*}\end{matrix} ] & ( 4 ) \\ {G}_{43} = [ \begin{matrix}{s}_{1} & {s}_{2} & - x {s}_{1} \\ - {s}_{2}^{*} & {s}_{1}^{*} & x {s}_{2}^{*} \\ {s}_{3} & {s}_{4} & x {s}_{3} \\ {x}^{*} {s}_{4}^{*} & - {x}^{*} {s}_{3}^{*} & {s}_{4}^{*}\end{matrix} ] & ( 5 ) \\ {G}_{44} = [ \begin{matrix}{s}_{1} & {s}_{2} & - {xs}_{1} & - {xs}_{2} \\ - {s}_{2}^{*} & {s}_{1}^{*} & x {s}_{2}^{*} & - x {s}_{1}^{*} \\ {s}_{3} & {s}_{4} & x {s}_{3} & - x {s}_{4} \\ {x}^{*} {s}_{4}^{*} & - {x}^{*} {s}_{3}^{*} & {s}_{4}^{*} & {s}_{3}^{*}\end{matrix} ] & ( 6 )\end{matrix}$$

FIG. 3B is a block diagram of a receiver having N′ receive antennas 304-1′ to 304-N′ in the space-time block coding apparatus. Referring to FIG. 3B, the receiver is comprised of a channel estimator 305 for performing a channel estimation on space-time block codes received from the transmitter, a space-time block decoder 306 for computing decision metrics for all transmitted signals by multiplying the channel estimation value by the space-time block codes received through the receive antennas 304-1′ to 304-N′ and thus estimating symbols, and a symbol demapper 307 for generating binary data from the estimated symbols. For details, see Tarokh, et. al., “Space Time Block Coding from Original Design”, IEEE Trans. On Info. Theory, Vol. 45, pp. 1456-1467, July 1999.

The orthogonal space-time block coding apparatus uses N transmit antennas and a 2^{b}-ary modulation scheme, by way of example. For the input of the binary data b₁b₂ . . . bᵢ, the symbol mapper 301 of the transmitter generates Nₜ symbols, sⱼ(j=1, 2, . . . , Nₜ) by mapping every 2^{b} bits to one symbol, and generates a QPSK symbol x by mapping 2 bits to the symbol. Here, xε{1, 2, −j, j}.

In this way, the orthogonal space-time block coding according to the present invention produces more symbols than the conventional system. Specifically, the former creates Nₜ symbols (Nₜ=2 for N=2, and Nₜ=4 for N=3, 4) and one QPSK symbol x, whereas the latter creates Nₜ symbols (Nₜ=2 for N=2, and Nₜ=3 for N=3, 4).

In Equation (4), Equation (5) and Equation (6), G₂₂ represents a space-time block code for two transmit antennas, G₄₃ represents a space-time block code for three transmit antennas, and G₄₄ represents a space-time block code for four transmit antennas according to the present invention. In each of the matrices, an i^{th} row represents a signal transmitted at an i^{th} time, and a j^{th} column represents a signal transmitted through a j^{th} transmit antenna. The space-time block coding is carried out using the transmission encoding matrix in the space-time block encoder 302.

In the receiver illustrated in FIG. 3B, after the channel estimation in the channel estimator 305, the space-time block decoder 306 detects transmitted signals using the channel estimation value and the received signals by using a maximum likelihood detection. The receiver operates on a basis of a space-time block code used in the transmitter. That is, for a received signal of the length of the space-time block code, the decision metric is computed over all possible combinations of the transmission symbols sⱼ(j=1, 2, . . . , Nₜ) and the symbol x according to a decision metric formula and transmission symbols that minimize the decision metric is selected. The symbol demapper 307 demodulates the transmission symbols into bits. In this way, the transmitted signal is detected.

In the space-time block coding of the present invention, the receiver can use a simple maximum likelihood detection technique. Its principle will be detailed later.

The operational principle will be described using G₂₂ and G₄₃ as an example. The same principle is applied to the other coding matrices and thus their description is not provided here.

For two transmit antennas (G₂₂), a typical space-time block code to be transmitted for two symbol periods is expressed as in Equation 7:

$$S = [ \begin{matrix}{s}_{1} & {s}_{2} \\ {s}_{3} & {s}_{4}\end{matrix} ] \qquad ( 7 )$$

where s₁, s₂, s₃ and s₄ are free symbols. To make the two columns orthogonal in the matrix, the inner product of the two columns must be zero and thus the condition s₁*s₂+s₃*s₄₌₀ must be satisfied. If s₁ and s₃ are determined from 2^{b}-bit binary data by 2^{b}-ary modulation and s₂=−xs₃*, it follows that s₄=xs₁*. Therefore, the transmission matrix is expressed as Equation (4).[

To have s₁, s₂, s₃ and s₄ to exist on the same constellation, an auxiliary symbol xε{−1, 1, −j, j} is determined from 2-bit binary data.

Consequently, for QPSK, a data rate of 1.5 is achieved since three symbols are transmitted for two symbol periods. For 16QAM (16-ary Quadrature Amplitude Modulation), a data rate of 1.25 is achieved since 2.5 symbols are transmitted for two symbol periods.

In the receiver, the maximum likelihood detection scheme detects s₁, s₂ and x that minimize the decision metric shown in Equation 8:

$$M ( {s}_{1} , {s}_{2} , x ) = {\sum }_{m = 1}^{M} ( {\vert {r}_{1 , m} - {α}_{1 , m} {s}_{1} - {α}_{2 , m} {s}_{2} \vert}^{2} + {\vert {r}_{2 , m} - {α}_{1 , m} {s}_{2}^{*} x - {α}_{2 , m} {s}_{1}^{*} x \vert}^{2} ) \qquad ( 8 )$$

where r_{i,m} is a signal received at an m^{th} receive antenna at an 1 time, and αn_{j,m} is a channel gain from an n^{th} transmit antenna to the m^{th} receive antenna. With x fixed, the above decision metric is divided into two parts as shown in Equations 9 and 10:

$$\begin{matrix}{M}_{1} ( {s}_{1} , x ) = - {\sum }_{m = 1}^{M} 2 Re [ ( {r}_{1 , m} {α}_{1 , m}^{*} + {r}_{2 , m}^{*} {α}_{2 , m} x ) {s}_{1}^{*} ] + {\vert {s}_{1} \vert}^{2} {\sum }_{m = 1}^{M} {\sum }_{n = 1}^{2} {\vert {α}_{n , m} \vert}^{2} & ( 9 ) \\ {M}_{2} ( {s}_{2} , x ) = - {\sum }_{m = 1}^{M} 2 Re [ ( {r}_{1 , m} {α}_{2 , m}^{*} - {r}_{2 , m}^{*} {α}_{1 , m} x ) {s}_{2}^{*} ] + {\vert {s}_{2} \vert}^{2} {\sum }_{m = 1}^{M} {\sum }_{n = 1}^{N} {\vert {α}_{n , m} \vert}^{2} & ( 10 )\end{matrix}$$

Equation (9) is confined to s₁ and Equation (10) is confined to s₂. Therefore, detecting an ordered pair s₁, s₂ that minimizes M(s₁, s₂, x) with respect to the fixed x amounts to detecting s₁ that minimizes M₁(s₁, x) and s₂ that minimizes M₂(s₂, x), separately.

The receiver computes minimum values of M₁(s₁, x) and M₂(s₂, x) and s₁ and s₂ in the minimum values over every xε{−1, 1, −j, j} and selects S1, S2, x that minimizes M₁(s₁, x)+M₂(s₂, x). This feature leads to a decoding complexity increase of 2² times relative to conventional space-time block codes.

Meanwhile, for three transmit antennas, a space-time block code to be transmitted for four symbol periods is expressed as in Equation 11:

$$S = [ \begin{matrix}{s}_{1} & {s}_{2} & {s}_{7} \\ - {s}_{2}^{*} & {s}_{1}^{*} & - {s}_{8}^{*} \\ {s}_{3} & {s}_{4} & {s}_{5} \\ {s}_{6}^{*} & - {s}_{5}^{*} & {s}_{4}^{*}\end{matrix} ] \qquad ( 11 )$$

where s₁, s₂, s₃, s₄, s₅, s₆, s₇, and s₈ are free symbols.

To make every two columns orthogonal in the matrix, the inner product of the two columns must be zero and thus the condition s₆s₅*−s₄s₃=0, s₇s₁*+s₅s₃*=0, s₈s₂*+s₃s₅*=0 must be satisfied. If s₅=xs₃, the transmission matrix is expressed as Equation (5).

The free symbols s₁, s₂, s₃, s₄, s₅ (or s₁, s₂, s₃, s₄) and the auxiliary symbol x are determined from input binary data. As in the case of two transmit antennas, s₁, s₂, s₃, s₄ are determines from 2^{b}-bit binary data by 2^{b}-ary modulation and x is determined from 2-bit binary data by QPSK. xε{−1, 1, −j, j}.

Consequently, for QPSK, a data rate of 1.25 is achieved since five symbols are transmitted for four symbol periods. For 16QAM, a data rate of 1.125 is achieved since 4.5 symbols are transmitted for four symbol periods. In this way, a transmit diversity gain of 2 is achieved, but with simple decoding. The maximum likelihood detection for three transmit antennas in the receiver can be deduced similarly to that for two transmit antennas. Thus, its description is not provided here.

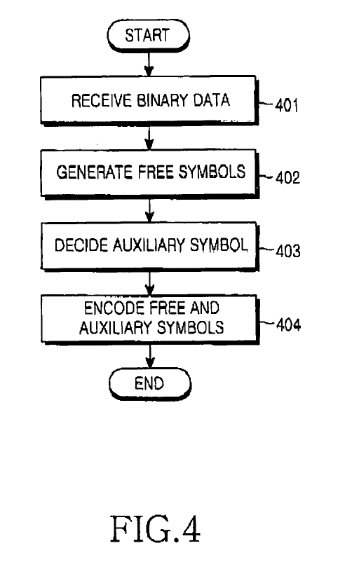

FIG. 4 is a flowchart illustrating the space-time block coding method according to the present invention.

Referring to FIG. 4, binary data is received in step 401. In step 403, free symbols and an auxiliary symbol are determined by dividing the binary data into units of a predetermined number of bits. The auxiliary symbol is a QPSK coefficient value by which the sum of inner products of an encoding matrix generated using the free symbols is zero. The free symbols and the auxiliary symbol are coded according to the encoding matrix and transmitted through transmit antennas in step 404.

The introduction of an auxiliary symbol into a space-time block code structure and the control of the requirements of the auxiliary symbol make a trade-off between the data rate and the diversity order possible in the present invention. As described before, if QPSK is adopted, the data rate for two transmit antennas is 1.5 symbols/transmission. For three or four transmit antennas, the data rate is 1.25 symbols/transmission.

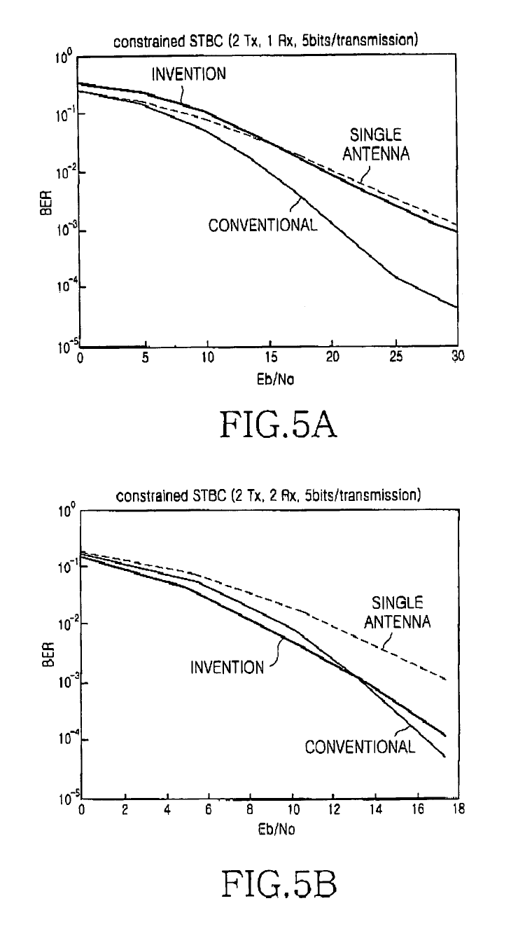

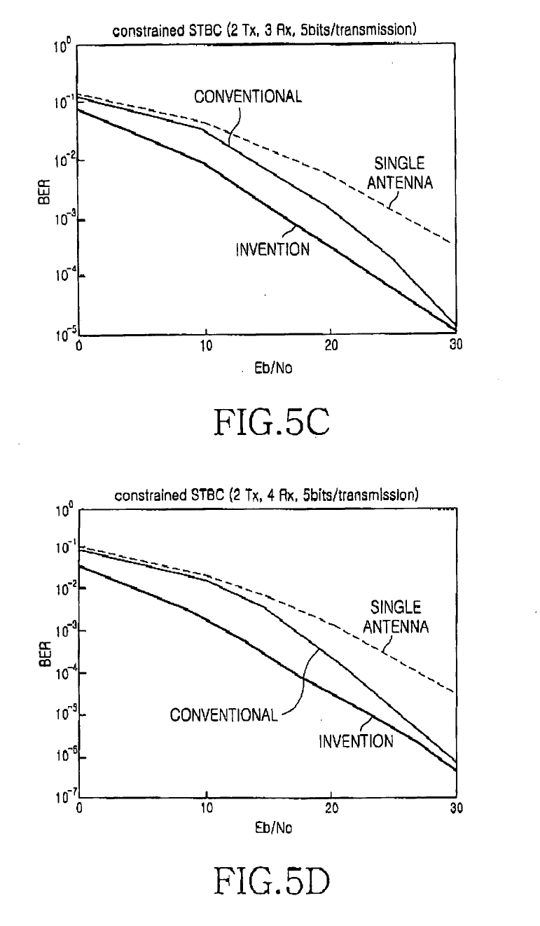

FIGS. 5A to 5D are graphs comparing a conventional orthogonal space-time block coding with the orthogonal space-time block coding of the present invention in terms of the BER performance.

For a data rate of 5 bits/transmission, the following decoding schemes are used.

TABLE 1

| | Conventional | Present invention |
|---|---|---|
| modulation | s₁, s₂: 32QAM | s₁, s₂; 16QAM x: QPSK |

Referring to FIG. 5A, in the case where a single receive antenna is used, the inventive orthogonal space-time block coding shows a degraded performance compared to the conventional one. As illustrated in FIGS. 5B, 5C and 5D, as the number of receive antennas increases to 2, 3 and 4, the receive diversity gain is also increased, thereby compensating for the lack of the transmit diversity gain that results in the embodiment of the present invention. Also, the resulting multiplexing gain, which is achieved by simultaneous transmission of a large amount of data, leads to an excellent BER performance, as compared to the conventional method. While two 32QAM signals are transmitted in the conventional method, two 16QAM signals and one QPSK signal are transmitted in the present invention. For example, for a BER=1e−3, the present invention achieves a gain of 2.5 dB for three receive antennas and a gain of 2.7 dB for four receive antennas, relative to the conventional method.

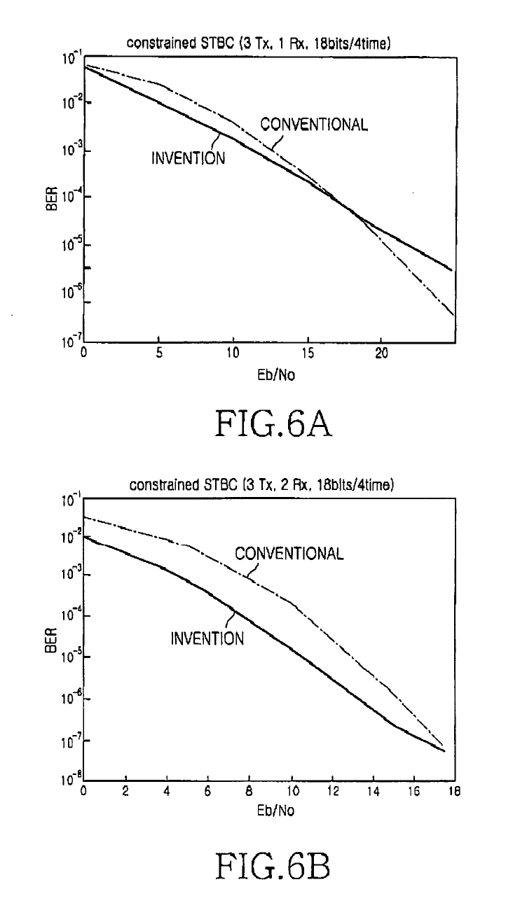

FIGS. 6A and 6B are graphs comparing the conventional orthogonal space-time block coding with the orthogonal space-time block coding of the present invention in terms of the BER performance in the case where three transmit antennas are used.

For a data rate of 18 bits/4 transmissions, the following decoding schemes are used.

TABLE 1

| | Conventional | Present invention |
|---|---|---|
| modulation | s₁, s₂, s₃: 64QAM | s₁, s₂, s₃: 16QAM x: QPSK |

In the case where three transmit antennas are used, even if the receiver adopts a single receive antenna as illustrated in FIG. 6A, the present invention exhibits a better BER performance than the conventional method for BER>1e−4. If two receive antennas are used as illustrated in FIG. 6B, the present invention achieves a gain of 3 dB for BER=1e−3, compared to the conventional method.

The space-time block coding using an auxiliary symbol is effective in a communication system, especially using two or more transmit antennas and one or more receive antennas.

In accordance of the present invention as described above, aside from free symbols derived from input data, an auxiliary symbol is introduced which serves as a coefficient that makes the sum of the inner products of a transmission encoding matrix equal to zero in a multiple antenna system. The free symbols are transmitted along with the auxiliary symbol, thereby increasing data rate.

The present invention is more flexible than the conventional method in that space-time block codes having various diversity gains and data rates can be designed through control of the requirements of the auxiliary symbol. In addition, the decoding complexity of the space-time block codes is kept to a minimum.

The space-time block coding method of the present invention can be programmed so that it is stored in a recoding medium (e.g. CD ROM, RAM, floppy disk, hard disk, optoelectric disk, etc.) in a form readable by a computer.

While the invention has been shown and described with reference to a certain preferred embodiment thereof, it will be understood by those skilled in the art that various changes in form and details may be made therein without departing from the spirit and scope of the invention as defined by the appended claims.

1. A space-time block coding method using an auxiliary symbol in a multiple transmit/receive antenna system, comprising the steps of:
(1) receiving binary data to be transmitted;
(2) generating free symbols and an auxiliary symbol by dividing the received binary data into units of a predetermined number of bits; and
(3) encoding the free symbols and the auxiliary symbol according to an encoding matrix and transmitting the coded free symbols and auxiliary symbol.

2. The space-time block coding method of claim 1, wherein the auxiliary symbol is a coefficient value that forces the sum of inner products of the encoding matrix to be equal to zero.

3. The space-time block coding method of claim 1, wherein the auxiliary symbol is a QPSK (Quadrature Phase Shift Keying) modulation symbol.

4. The space-time block coding method of claim 2, wherein the auxiliary symbol is a QPSK (Quadrature Phase Shift Keying) modulation symbol.

5. The space-time block coding method of claim 3, wherein for two transmit antennas, the encoding matrix is
$${G}_{22} = [ \begin{matrix}{s}_{1} & {s}_{2} \\ - {xs}_{2}^{*} & {xs}_{1}^{*}\end{matrix} ]$$
where s₁ and s₂ are the free symbols and x is the auxiliary symbol.

6. The space-time block coding method of claim 4, wherein for two transmit antennas, the encoding matrix is
$${G}_{22} = [ \begin{matrix}{s}_{1} & {s}_{2} \\ - {xs}_{2}^{*} & {xs}_{1}^{*}\end{matrix} ]$$
where s₁ and s₂ are the free symbols and x is the auxiliary symbol.

7. The space-time block coding method of claim 3, wherein for three transmit antennas, the encoding matrix is
$${G}_{43} = [ \begin{matrix}{s}_{1} & {s}_{2} & - x {s}_{1} \\ - {s}_{2}^{*} & {s}_{1}^{*} & x {s}_{2}^{*} \\ {s}_{3} & {s}_{4} & x {s}_{3} \\ {x}^{*} {s}_{4}^{*} & - {x}^{*} {s}_{3}^{*} & {s}_{4}^{*}\end{matrix} ]$$
where s₁, s₂, s₃ and s₄ are the free symbols and x is the auxiliary symbol.

8. The space-time block coding method of claim 4, wherein for three transmit antennas, the encoding matrix is
$${G}_{43} = [ \begin{matrix}{s}_{1} & {s}_{2} & - x {s}_{1} \\ - {s}_{2}^{*} & {s}_{1}^{*} & x {s}_{2}^{*} \\ {s}_{3} & {s}_{4} & x {s}_{3} \\ {x}^{*} {s}_{4}^{*} & - {x}^{*} {s}_{3}^{*} & {s}_{4}^{*}\end{matrix} ]$$
where s₁, s₂, s₃ and s₄ are the free symbols and x is the auxiliary symbol.

9. The space-time block coding method of claim 3, wherein for four transmit antennas, the encoding-matrix is
$${G}_{44} = [ \begin{matrix}{s}_{1} & {s}_{2} & - {xs}_{1} & - {xs}_{2} \\ - {s}_{2}^{*} & {s}_{1}^{*} & {xs}_{2}^{*} & - {xs}_{1}^{*} \\ {s}_{3} & {s}_{4} & {xs}_{3} & - {xs}_{4} \\ {x}^{*} {s}_{4}^{*} & - {x}^{*} {s}_{3}^{*} & {s}_{4}^{*} & {s}_{3}^{*}\end{matrix} ]$$
where s₁, s₂, s₃ and s₄ are the free symbols and x is the auxiliary symbol.

10. The space-time block coding method of claim 4, wherein for four transmit antennas, the encoding matrix is
$${G}_{44} = [ \begin{matrix}{s}_{1} & {s}_{2} & - {xs}_{1} & - {xs}_{2} \\ - {s}_{2}^{*} & {s}_{1}^{*} & {xs}_{2}^{*} & - {xs}_{1}^{*} \\ {s}_{3} & {s}_{4} & {xs}_{3} & - {xs}_{4} \\ {x}^{*} {s}_{4}^{*} & - {x}^{*} {s}_{3}^{*} & {s}_{4}^{*} & {s}_{3}^{*}\end{matrix} ]$$
where s₁, s₂, s₃ and s₄ are the free symbols and x is the auxiliary symbol.

11. The space-time block coding method of claim 1, wherein a receiver in the multiple transmit/receive antenna system performs a space-time block decoding method corresponding to the space-time block coding, the space-time block decoding method comprising the steps of:
(4) receiving a space-time block code generated by the space-time block coding and channel-estimating the space-time block code;
(5) calculating a decision metric corresponding to the transmitted signal by multiplying the channel estimation value by the space-time block code, thereby estimating symbols; and
(6) demapping the estimated symbols to binary data.

12. The space-time block coding method of claim 2, wherein a receiver in the multiple transmit/receive antenna system performs a space-time block decoding method corresponding to the space-time block coding, the space-time block decoding method comprising the steps of:
(4) receiving a space-time block code generated by the space-time block coding and channel-estimating the space-time block code;
(5) calculating a decision metric corresponding to the transmitted signal by multiplying the channel estimation value by the space-time block code, thereby estimating symbols; and
(6) demapping the estimated symbols to binary data.

13. The space-time block coding method of claim 11, wherein the step (5) comprises the steps of dividing the decision metric into two parts and obtaining s₁ and s₂ by calculating the two parts, separately, the two parts being equal to
$$\begin{matrix}{M}_{1} ( {s}_{1} , x ) = - {\sum }_{m = 1}^{M} 2 Re [ ( {r}_{1 , m} {α}_{1 , m}^{*} + {r}_{2 , m}^{*} {α}_{2 , m} x ) {s}_{1}^{*} ] + \\ {\vert {s}_{1} \vert}^{2} {\sum }_{m = 1}^{M} {\sum }_{n = 1}^{2} {\vert {α}_{n , m} \vert}^{2} \\ {M}_{2} ( {s}_{2} , x ) = - {\sum }_{m = 1}^{M} 2 Re [ ( {r}_{1 , m} {α}_{2 , m}^{*} + {r}_{2 , m}^{*} {α}_{1 , m} x ) {s}_{2}^{*} ] + \\ {\vert {s}_{2} \vert}^{2} {\sum }_{m = 1}^{M} {\sum }_{n = 1}^{2} {\vert {α}_{n , m} \vert}^{2}\end{matrix}$$
where x is fixed, r_{i,m} is a signal received at an m^{th} receive antenna at an i^{th} time, and αn_{j,m} is a channel gain from an n^{th} transmit antenna to the m^{th} receive antenna.

14. The space-time block coding method of claim 12, wherein the step (5) comprises the steps of dividing the decision metric into two parts and obtaining s₁ and s₂ by calculating the two parts, separately, the two parts being equal to
$$\begin{matrix}{M}_{1} ( {s}_{1} , x ) = - {\sum }_{m = 1}^{M} 2 Re [ ( {r}_{1 , m} {α}_{1 , m}^{*} + {r}_{2 , m}^{*} {α}_{2 , m} x ) {s}_{1}^{*} ] + \\ {\vert {s}_{1} \vert}^{2} {\sum }_{m = 1}^{M} {\sum }_{n = 1}^{2} {\vert {α}_{n , m} \vert}^{2} \\ {M}_{2} ( {s}_{2} , x ) = - {\sum }_{m = 1}^{M} 2 Re [ ( {r}_{1 , m} {α}_{2 , m}^{*} + {r}_{2 , m}^{*} {α}_{1 , m} x ) {s}_{2}^{*} ] + \\ {\vert {s}_{2} \vert}^{2} {\sum }_{m = 1}^{M} {\sum }_{n = 1}^{2} {\vert {α}_{n , m} \vert}^{2}\end{matrix}$$
where x is fixed, r_{i,m} is a signal received at an m^{th} receive antenna at an i^{th} time, and αn_{j,m i} is a channel gain from an n transmit antenna to the m^{th} receive antenna.

15. The space-time block coding method of claim 13, wherein the step of obtaining s₁ and s₂ comprises the step of detecting s₁ that minimizes M₁(s₁, x) and s₂ that minimizes M₂(s₂, x).

16. The space-time block coding method of claim 14, wherein the step of obtaining s₁ and s₂ comprises the step of detecting s₁ that minimizes M₁(s₁, x) and s₂ that minimizes M₂(s₂, x).
